(19) United States
(12) Patent Application Publication
(10) Pub. No.: US 2008/0184860 A1
(43) Pub. Date: Aug. 7, 2008

(54) PUNCH

(75) Inventor: Hung Yu Cheng, Siu Lek Yuen Shatin N.T. (HK)

Correspondence Address: MARSHALL, GERSTEIN & BORUN LLP, 233 S. WACKER DRIVE, SUITE 6300, SEARS TOWER, CHICAGO, IL, 60606, US

(73) Assignee: LECO STATIONERY MANUFACTURING COMPANY LIMITED, New Territories (HK)

(21) Appl. No.: 11/875,618

(22) Filed: Oct. 19, 2007

(30) Foreign Application Priority Data
Feb. 2, 2007 (CN) 200710007787.4

(51) Int. Cl. B26D 7/02

(52) U.S. Cl. 83/467.1

(57) ABSTRACT

A punch comprises a connecting bar and two punching means. The two punching means are mounted rotatably to the connecting bar. The punch according to the invention may punch two or three holes on sheets of paper as desired by rotating the connecting bar and one punching means since two punching means are mounted rotatably to the connecting bar.

### FIELD OF THE INVENTION

The invention relates to a punch.

### BACKGROUND OF THE INVENTION

A punch is used widely to punch sheets of paper to allow these punched sheets of paper to be retained in a file or a notebook. A conventional punch generally comprises two fixed punching means. In use, the fixed punching means may punch two holes on an edge of sheets of paper. However, three holes need to be punched on sheets of paper in some cases. The conventional punch can't meet this requirement.

Accordingly, there is a need for an improvement in the conventional punch.

### SUMMARY OF THE INVENTION

The present invention is proposed in consideration of the above problems in the conventional punch.

Therefore, an object of the invention is to provide a punch, which may punch two or three holes on sheets of paper as desired.

According to the invention, a punch is provided, comprising:

a connecting bar; and

two punching means;

wherein the two punching means are mounted rotatably to the connecting bar.

The punch according to the invention may punch two or three holes on sheets of paper as desired by rotating the connecting bar and one punching means since two punching means are mounted rotatably to the connecting bar,.

### BRIEF DESCRIPTION OF THE DRAWINGS

FIG. 1 is a perspective view of the punch according to the invention;

FIG. 2 is a top view of the punch according to the invention;

FIG. 3 is a front view of the punch according to the invention;

FIG. 4 is a rear view of the punch according to the invention;

FIG. 5 is a left view of the punch according to the invention;

FIG. 6 is a right view of the punch according to the invention;

FIG. 7 is an exploded perspective view of the punch according to the invention;

FIG. 8 is a bottom perspective view of the punch according to the invention, in which a part of one bottom cover is cut away to show the inner structure;

FIG. 9 shows a state in which the punch according to the invention is punching two holes on sheets of paper;

FIG. 10 shows that the punch according to the invention rotates from the state shown in FIG. 9 to a state for punching the third hole on sheets of paper;

FIG. 11 shows an initial state of one punching means provided with a locking means;

FIG. 12 is a cross section view of the punching means shown in FIG. 1 1;

FIG. 13 shows a state in which the punching means provided with the locking means is punching;

FIG. 14 is a cross section view of the punching means shown in FIG. 13;

FIG. 15 shows the punching means provided with the locking means in a locked state; and

FIG. 16 is a cross section view of the punching means shown in FIG. 15.

### DETAILED DESCRIPTION OF THE PREFERRED EMBODIMENTS

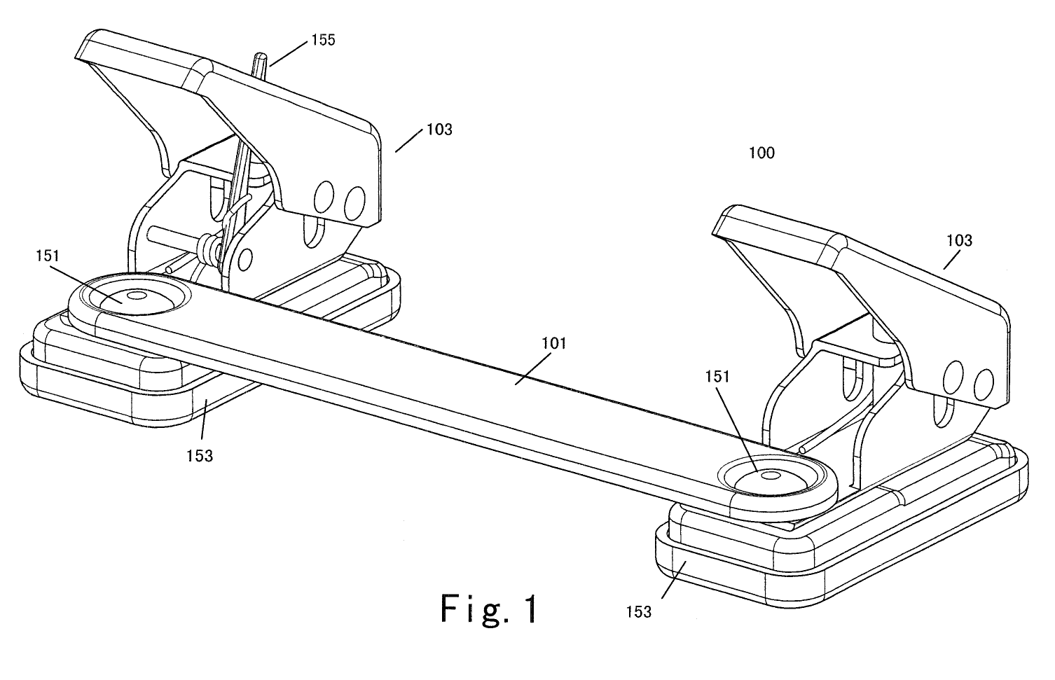

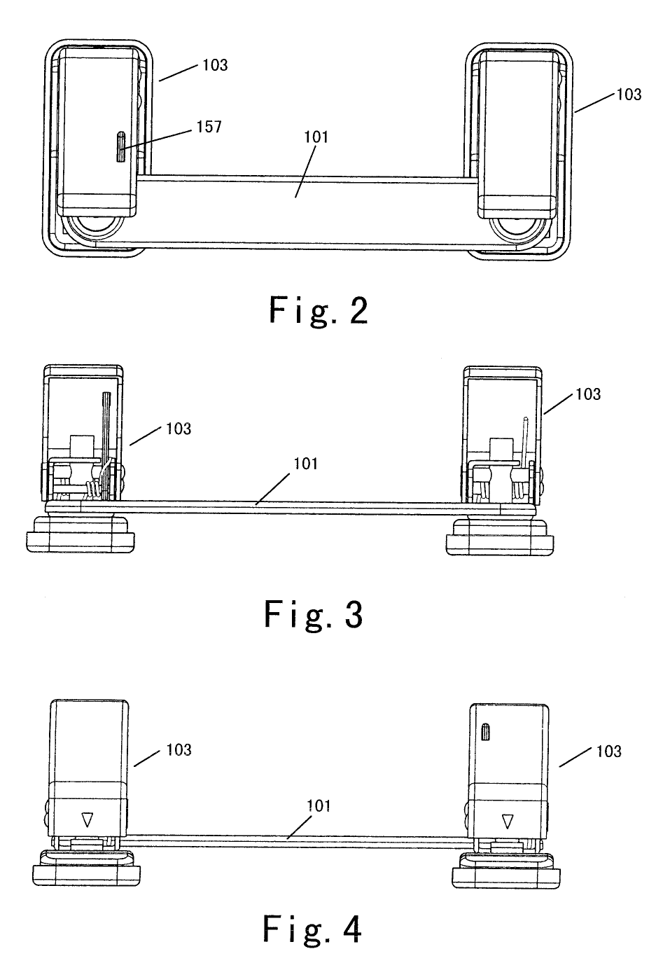

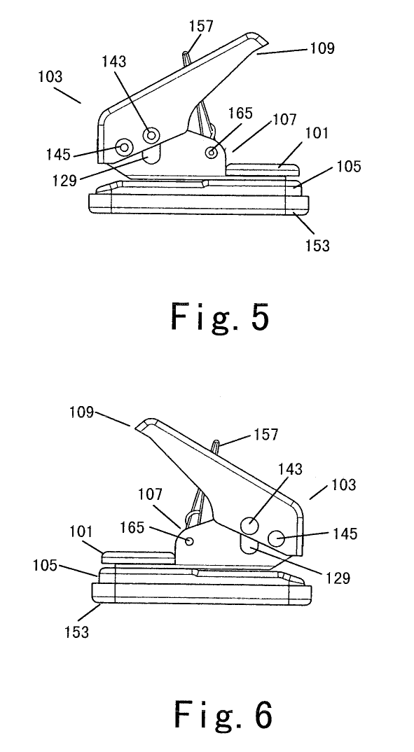

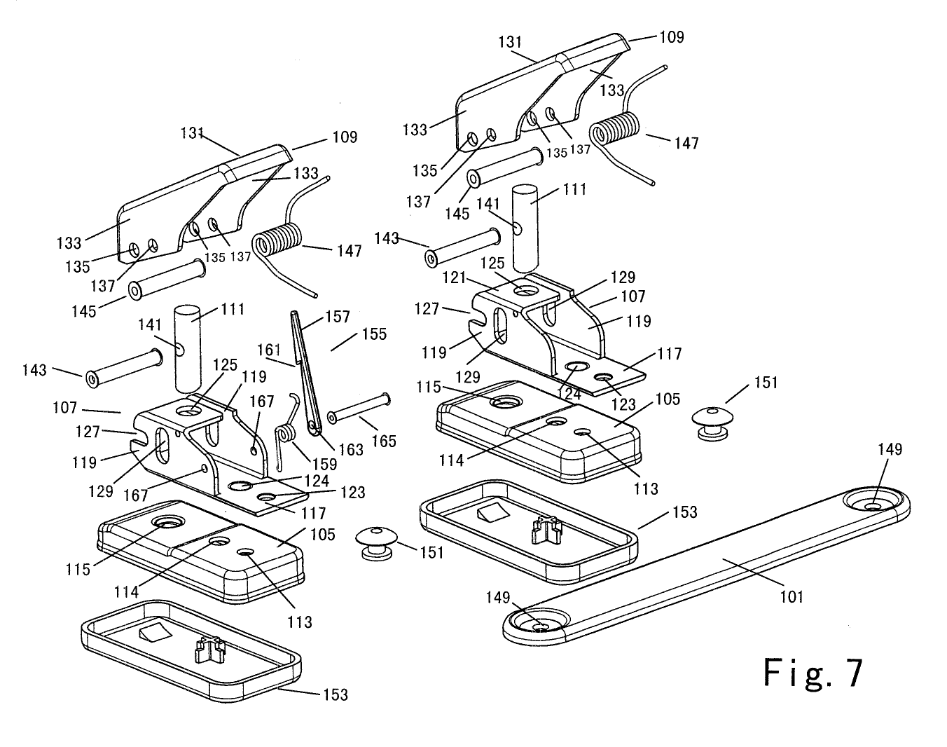

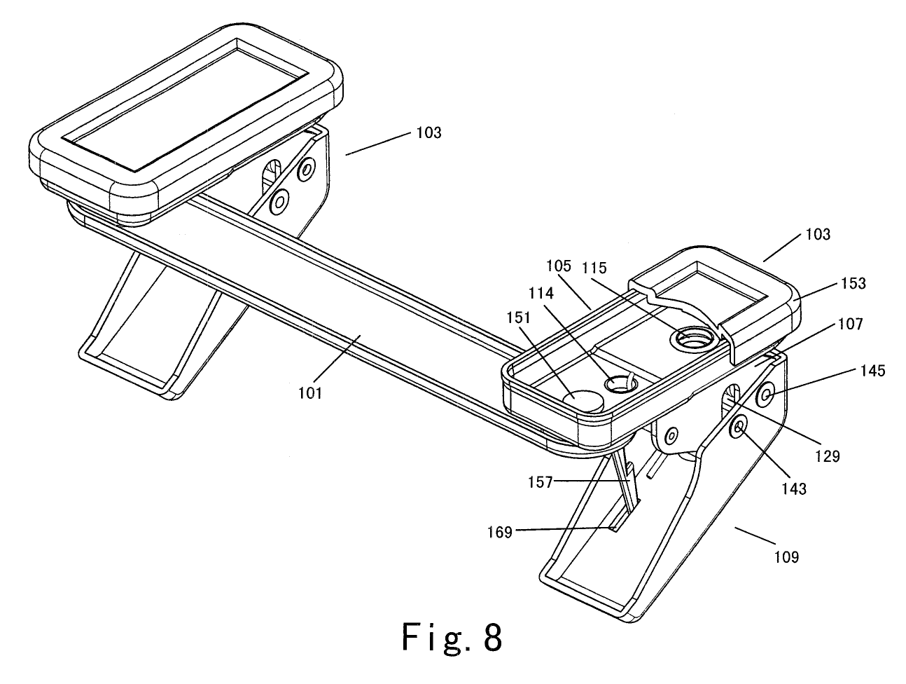

FIGS. 1-8 show a punch 100 according to the invention. The punch 100 according to the invention comprises a generally elongated and flat connecting bar 101 and two punching means 103. Each of two punching means 103 comprises a base 105, a bracket 107, a pressing portion 109 and a punching pin 111. The base 105 preferably has a cuboid shape with a bottom opened, and holes 113, 114 and 115 are formed on a top of the base. The bracket 107 comprises a bottom portion 117, two side portions 119 extending parallel to each other at two sides of the bottom portion 117 and formed integrally with the bottom portion 117, and a top portion 121 extending parallel with the bottom portion 117 from one side portion to other side portion. Holes corresponding to the holes 113, 114 and 115 in the base are formed on the bottom portion 117, of which the holes 123 and 124 corresponding to the holes 113 and 114 are visible in the drawing, but other hole corresponding to the hole 115 is invisible in the drawing. A hole 125 corresponding to the hole 115 in the base and the invisible hole in the bottom portion 117 is also formed on the top portion 121. A notch 127 is formed on one end of two side portions 119 respectively. An elongated slot 129 which is substantially perpendicular to the bottom portion 117 is formed respectively on the side portions 119 adjacent the notch 127. The pressing portion 109 comprises a top portion 131 and two side portions 133 extending parallel to each other at two sides of the top portion 131 and formed integrally with the top portion 131. The two side portions 133 have corresponding holes 135 and 137. The punching pin 111 has a through hole 141, and a sharp punching edge for punching sheets of paper is formed at the bottom end of the punching pin.

In assembly, the base 105 and the bracket 107 are fixed together to allow their holes 113, 114, 115 and 123, 124, 125 to be aligned with each other. A part of the base 105 provided with the hole 115 is lower than a part provided with the hole 113 and 114 such that a gap between the part of the base 105 provided with the hole 115 and the bottom portion 117 of the bracket 107 is large enough to insert sheets of paper to be punched. The punching pin 111 inserts into the aligned holes in the bottom portion 117 and the top portion 121 of the bracket 107, and a pin shaft 143 passes through the hole 137 in one side portion 133 of the pressing portion, the elongated slot 129 in one side portion 119 of the bracket, the through hole 141 in the punching pin 111, the elongated slot 129 in the other side portion 119 of the bracket and the hole 137 in the other side portion 133 of the pressing portion. Furthermore, a pin shaft 145 passes through the hole 135 in one side portion 133 of the pressing portion, the notch 127 in one side portion 119 of the bracket, a coil spring 147, the notch 127 in the other side portion 119 of the bracket and the hole 135 in the other side portion 133 of the pressing portion so that two free ends of the coil spring 147 abut against the bottom portion 117 of the bracket 107 and the top portion 131 of the pressing portion 109 respectively. Thus, the pressing portion 109 is mounted movably to the bracket 107 to form one punching means 103. A through hole 149 is formed respectively at both ends of the connecting bar 101. Both ends of the connecting bar 101 are placed respectively on one punching means 103. A connecting member 151 passes through the through hole 149 of the connecting bar 101, the hole 123 of the bracket 107 and the hole 113 of the base 105 so that each of two punching means 103 is connected rotatably with the connecting bar 101. A distance between the centers of the two punching means 103 is preferably equal to the distance between the holes in the standard loose-leaf sheets of paper. It can be seen that the rotation between the connecting bar 101 and the punching means 103 is limited by the bracket of the punching means 103. Preferably, the connecting bar 101 and the punching means 103 are configured so that the rotation of the connecting bar 101 and each punching means 103 around the connecting member 151 with respect to each other in one direction is limited to one position where the connecting bar 101 is perpendicular to each punching means 103, and the rotation in the direction opposite to the said direction is also limited to a position where the connecting bar is perpendicular to each punching means, i.e., a range of rotation of the connecting bar 101 with respect to the punching means around the connecting member 151 or a range of rotation of the punching means with respect to the connecting bar 101 around the connecting member 151 is limited to 180 degree. Furthermore, each punching means 103 may further comprise a bottom cover 153. The bottom cover 153 may attached onto the opened bottom of the base 105 to receive the paper debris.

The punch 100 according to the invention may further comprise a locking means 155 provided at one punching means 103. Preferably, the locking means 155 comprises a locking tab 157 and a coil spring 159. The locking tab 15 7 comprises a step or hook shaped locking portion 161 located in the middle and a hole 163 located at the bottom end. When assembled, the bottom end of the locking tab 157 inserts into an elongated opening 169 formed on the top portion 131 of the pressing portion 109 of the punching means. A pin shaft 165 passes through a hole 167 in one side portion 119 of the bracket, the coil spring 159, the hole 163 in the bottom end of the locking tab 157 and the hole 167 in the other side portion 119 of the bracket so that one free end of the coil spring 159 is mounted onto the locking tab 157. The coil spring 159 tends to cause one side of the locking tab 157 provided with the locking portion 161 to rest always against one end of the elongated opening 169 in the top portion 131 of the pressing portion, thereby keeping the punching pin Ill passing through sheets of paper to lock the punching means 103 at sheets of paper after the pressing portion 109 is pressed down to punch sheets of paper. It should be understood that the locking means described above is a preferred form of the invention and the locking means may be in any form as long as it may keep the punching pin 111 passing through sheets of paper after punching sheets of paper. For example, the coil spring may be unnecessary and the locking tab may be set at the locked position or the unlocked position directly by hand; the elongated opening may not be formed in the top portion of the pressing portion and the locking tab may act directly on the pressing portion. Furthermore, both punching means may be provided with the locking means.

Operation of the punch 100 according to the invention will be described in the following. Firstly, the punch 100 is adjusted to a state shown in FIG. 1, i.e., a state where two punching means 103 are generally perpendicular to the connecting bar 101. Sheets of paper 171 are inserted into the gap between the base 105 of the two punching means 103 and the bracket 107. Then, the pressing portion 109 of each punching means 103 is pressed down to punch two holes on the edge of sheets of paper.

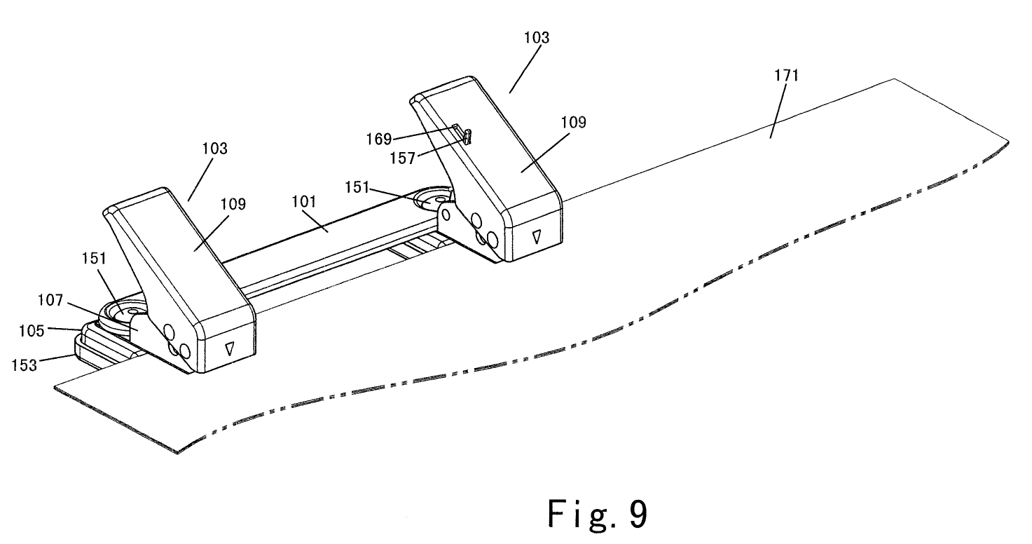

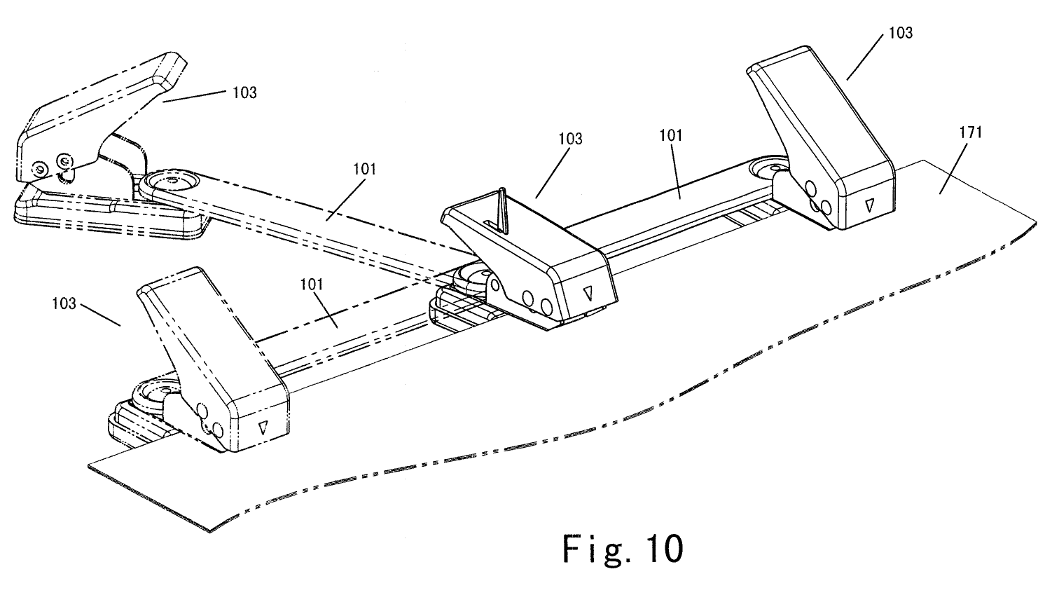

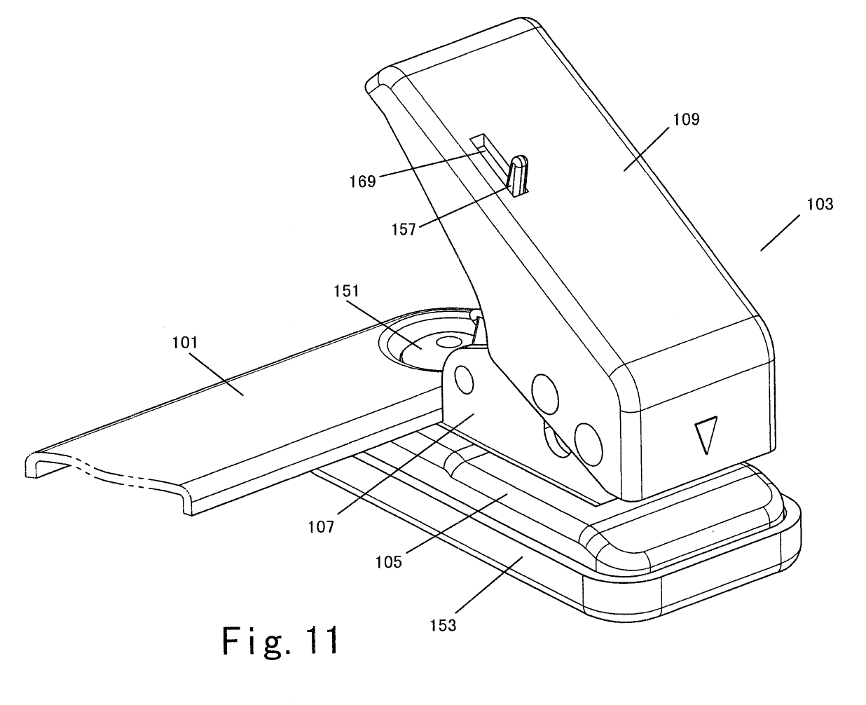

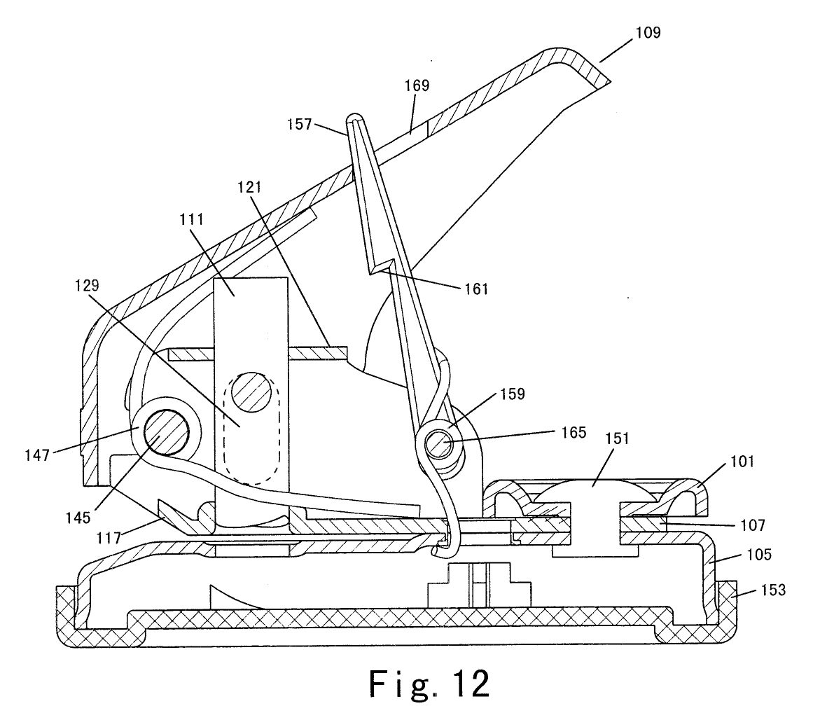

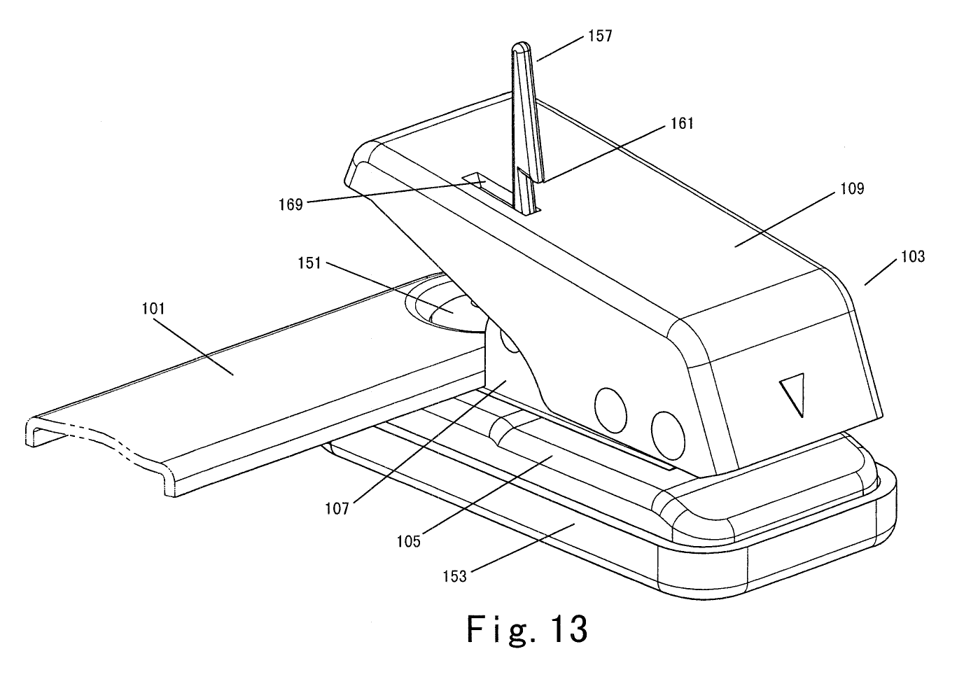

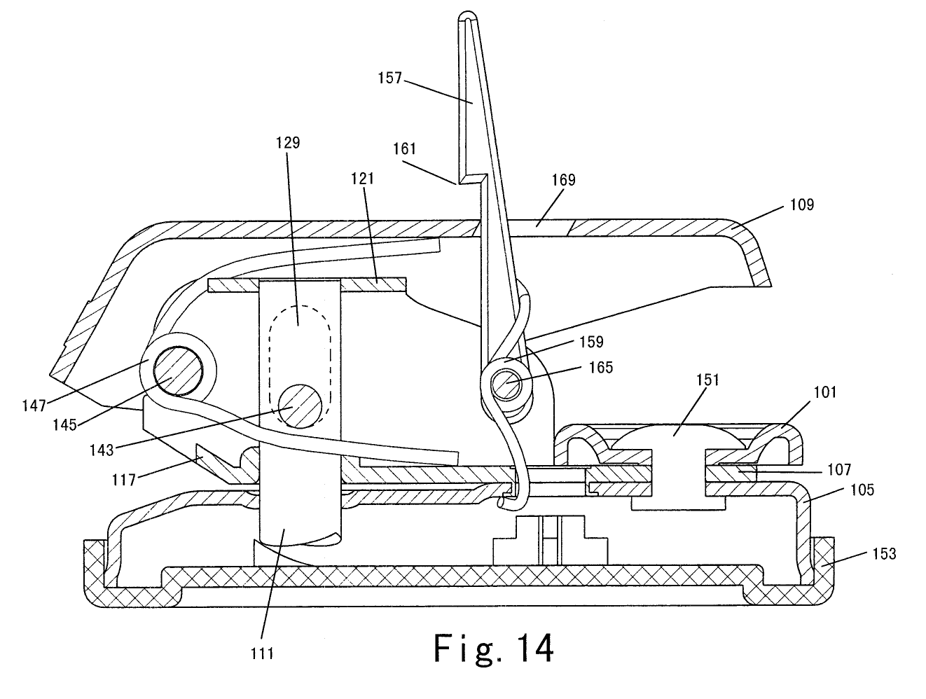

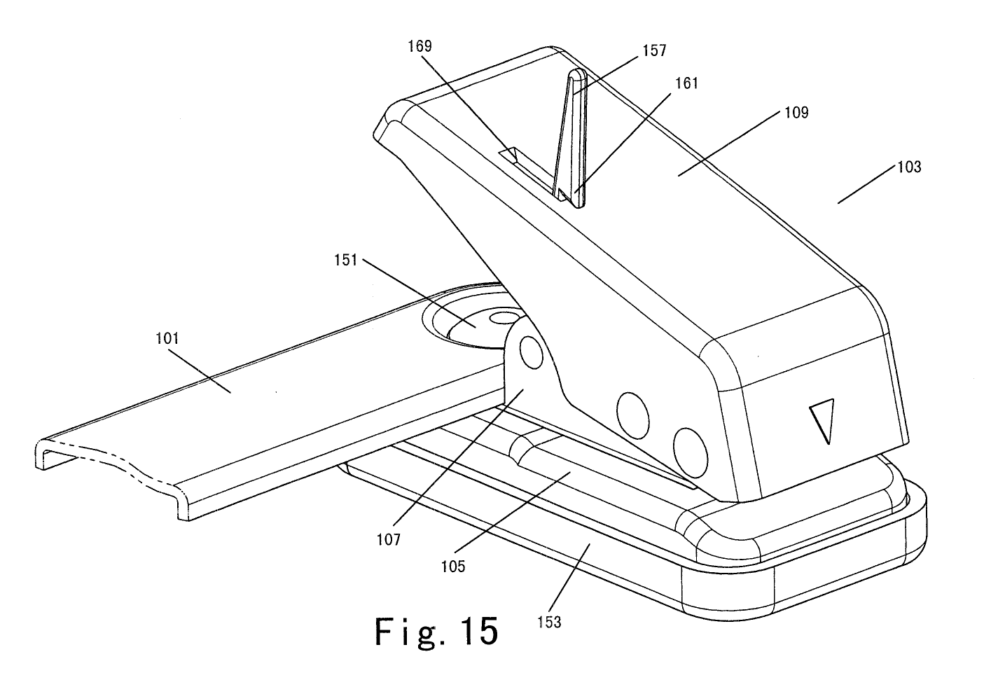

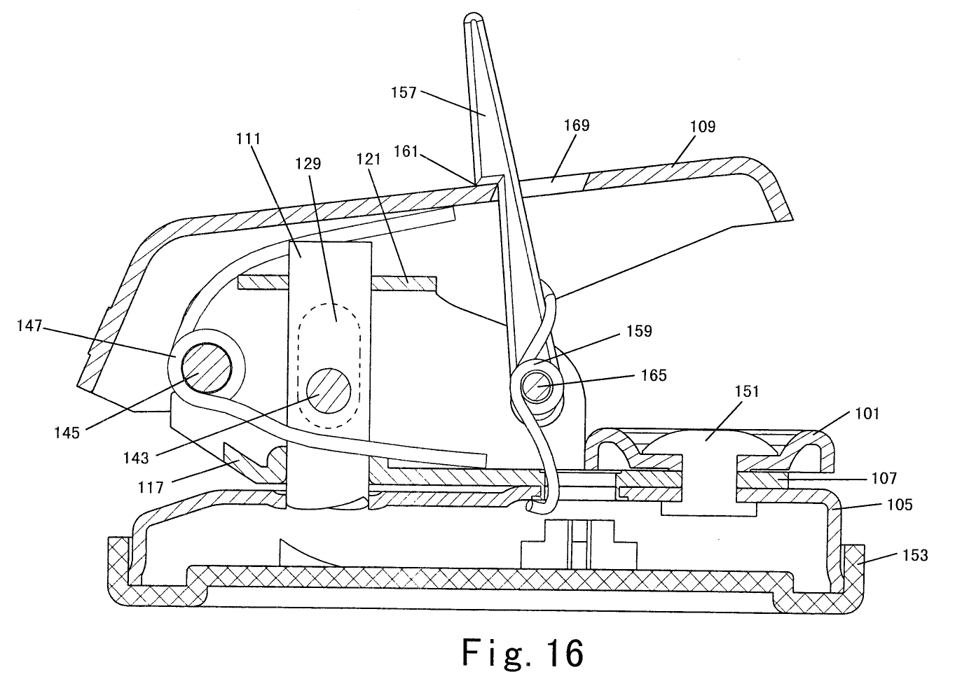

If three holes are to be punched in sheets of paper, the punching means 103 provided with the locking means is located at a position on sheets of paper where the middle hole is to be punched, as shown in FIG. 9. Then, the pressing portion 109 of each punching means 103 is pressed down to punch two holes on the edge of sheets of paper. As shown in FIG. 13 and FIG. 14, when the pressing portion 109 of the punching means 103 provided with the locking means is pressed down, the pressing portion 109 drives the punching pin 111 to move downward to punch sheets of paper. At the same time, the locking portion 161 of the locking tab 157 projects out of the elongated opening 169 in the pressing portion 109. When the pressing of the pressing portion 109 is released, as shown in FIG. 15 and FIG. 16, the locking portion 161 of the locking tab 157 catches the pressing portion 109 under the action of the coil spring 159 to prevent the pressing portion 109 together with the punching pin 111 from going back to the initial state under the action of the coil spring 147, i.e., the punching pin 111 still keeps a state of passing through sheets of paper to prevent sheets of paper from displacing. For clarity, sheets of paper are not shown in FIGS. 11-16. While the punching means 103 provided with the locking device keeps the locked state shown in FIG. 15 and FIG. 16, the connecting bar 101 rotates by 180 degree around the punching means 103 provided with the locking means, and the other punching means 103 rotates by 180 degree with respect to the connecting bar 101 to allow sheets of paper to be inserted into the gap between the base 105 and the bracket 107 of the other punching means 103, as shown in FIG. 10. At this time, the pressing portion 109 of the other punching means 103 is pressed down to punch the third hole on sheets of paper 171. Then, the locking tab 157 is moved manually by resisting against the acting force of the coil spring 159, causing the locking portion 161 of the locking tab 157 to separate from the pressing portion 109. The punching means 103 provided with the locking device goes back to the initial state, and the punch 100 may be removed from sheets of paper. The dotted lines in FIG. 10 show the connecting bar and the punching means during rotation.

Although the preferred embodiments of the invention were described in detail taken in conjunction of the accompanying drawings in a non-limiting sense, it should be understood that various changes and modifications could be made without departing from the scope defined by accompanying claims of the invention. For example, the punching means may not be limited to the above type and may be any known type of punching means. The locking means is not necessary and a punching means may be kept manually at the locked state. Furthermore, the locking means is also applicable to one punching means with two or more punching pins.

What is claimed is:

1. A punch comprising:
a connecting bar; and
two punching means;
wherein the two punching means are mounted rotatably to the connecting bar.

2. The punch according to claim 1, wherein the rotation of the connecting bar and each of two punching means with respect to each other in one direction is limited to a position where the connecting bar is perpendicular to each of two punching means, and the rotation in an opposite direction is also limited to a position where the connecting bar is perpendicular to each of two punching means.

3. The punch according to claim 1, wherein a distance between the centers of the two punching means is equal to a distance between adjacent holes in standard loose-leaf sheets of paper.

4. The punch according to claim 1, wherein at least one punching means is provided with a locking means for locking the at least one punching means at a punching state.

5. The punch according to claim 1, wherein each of the two punching means comprises a base, a bracket, a pressing portion and a punching pin, and they are assembled movably together by a spring and a pin shaft so that the punching pin moves downward by pressing the pressing portion.

6. The punch according to claim 5, wherein at least one punching means is provided with a locking means for locking the at least one punching means at a punching state.

7. The punch according to claim 6, wherein the locking means comprises a locking tab mounted to one of two punching means, and the locking tab has a locking portion for locking the pressing portion at a pressed state.

8. The punch according to claim 7, wherein the locking means further comprises a spring, and the spring acts on the locking tab to allow the locking portion to tend to lock the pressing portion.

9. The punch according to claim 8, wherein an elongated opening is formed on a top of the pressing portion, and the locking tab passes through the elongated opening, the locking portion of the locking tab catches the pressing portion during locking the pressing portion.

10. The punch according to claim 5, wherein each of the two punching means further comprises a bottom cover attached to the base.

11. A punching means comprising a base, a bracket, a pressing portion and a punching pin, and they are assembled movably together by a spring and a pin shaft so that the punching pin moves downward by pressing the pressing portion, wherein the punching means further comprises a locking means for locking the punching means at a punching state.

12. The punching means according to claim 11, wherein the locking means comprises a locking tab mounted to the punching means, and the locking tab has a locking portion for locking the pressing portion at a pressed state.

13. The punching means according to claim 12, wherein the locking means further comprises a spring, and the spring acts on the locking tab to allow the locking portion to tend to lock the pressing portion.

14. The punching means according to claim 13, wherein an elongated opening is formed on a top of the pressing portion, and the locking tab passes through the elongated opening, the locking portion of the locking tab catches the pressing portion during locking the pressing portion.
